(19) United States
(12) Patent Application Publication
(10) Pub. No.: US 2023/0274406 A1
(43) Pub. Date: Aug. 31, 2023

(54) IDENTIFYING DERIVATIVES OF DATA ITEMS

(71) Applicant: BRITISH TELECOMMUNICATIONS PUBLIC LIMITED COMPANY, London (GB)

(72) Inventors: Jonathan ROSCOE, London (GB); Robert HERCOCK, London (GB)

(21) Appl. No.: 18/246,221

(22) PCT Filed: Sep. 27, 2021
(86) PCT No.: PCT/EP2021/076483

§ 371 Date: Mar. 22, 2023

(30) Foreign Application Priority Data
Sep. 29, 2020 (GB) 2015403.5

(51) Int. Cl. G06T 7/00; H04L 9/00; G06V 10/56

(52) U.S. Cl. CPC G06T 7/0002; H04L 9/50; G06V 10/56

(57) ABSTRACT

A computer implemented method of determining an association between disparate first and second data items wherein the second data item is at least partly derived from the first data item, the method comprising: evaluating a cryptographic hash to each result of each of a plurality of disparate feature extraction methods, each feature extraction method being applied to each of the first and second data items to generate a set of hashes for each data item; responsive to a non-empty set of hashes in the intersect of the sets of hashes for each data item, identifying an association between the first and second data items.

The present invention relates to the identification of data items that are derivatives of other data items.

Data can be stored in data items such as files, records, streams or data objects including data such as documents, images, audio, video, web-pages, composite documents, and other well-known data formats, styles and structures. Such data is increasingly susceptible to misuse by the generation of adapted, manipulated or otherwise derived versions of data items. For example, deepfakes are data items such as images or videos in which a portion of data in an original data item is modified such as to include data not present in the original data item, or to exclude data originally present, or a combination of both. Such techniques have been used to generate, for example, images and videos including a likeness of a person or thing not present in an original. Equivalent misuse can arise in data items of other types of data, such as documents, audio, webpages and the like with data added and/or removed.

Such misuse can cause considerable damage, such as by misrepresenting individuals, organisations or data itself. Accordingly, there is a need to identify such misuse of data items.

According to a first aspect of the present invention, there is provided a computer implemented method of determining an association between disparate first and second data items wherein the second data item is at least partly derived from the first data item, the method comprising: evaluating a cryptographic hash to each result of each of a plurality of disparate feature extraction methods, each feature extraction method being applied to each of the first and second data items to generate a set of hashes for each data item; responsive to a non-empty set of hashes in the intersect of the sets of hashes for each data item, identifying an association between the first and second data items.

Preferably, the plurality of feature extraction methods include one or more of: image noise extraction; colour distribution determination; intensity distribution; microtexture determination; structure determination; edge identification; object detection; metadata extraction; symbol frequency measurement; n-gram extraction; syntactic structure identification; and classification.

Preferably, the method further comprises, responsive to the identification of an association, identifying the second data item as a derivative of the first data item.

Preferably, the first and second data items include renderable media data and the association identifies the second data item as a deepfake.

Preferably, the method further comprises, responsive to the identification of an association, preventing access to the second data item.

Preferably, the set of hashes for the first data item are stored in a blockchain database for comparison with the set of hashes for the second data item to identify the intersect of the sets.

According to a second aspect of the present invention, there is a provided a computer system including a processor and memory storing computer program code for performing the steps of the method set out above.

According to a third aspect of the present invention, there is a provided a computer system including a processor and memory storing computer program code for performing the steps of the method set out above.

Embodiments of the present invention will now be described, by way of example only, with reference to the accompanying drawings, in which:

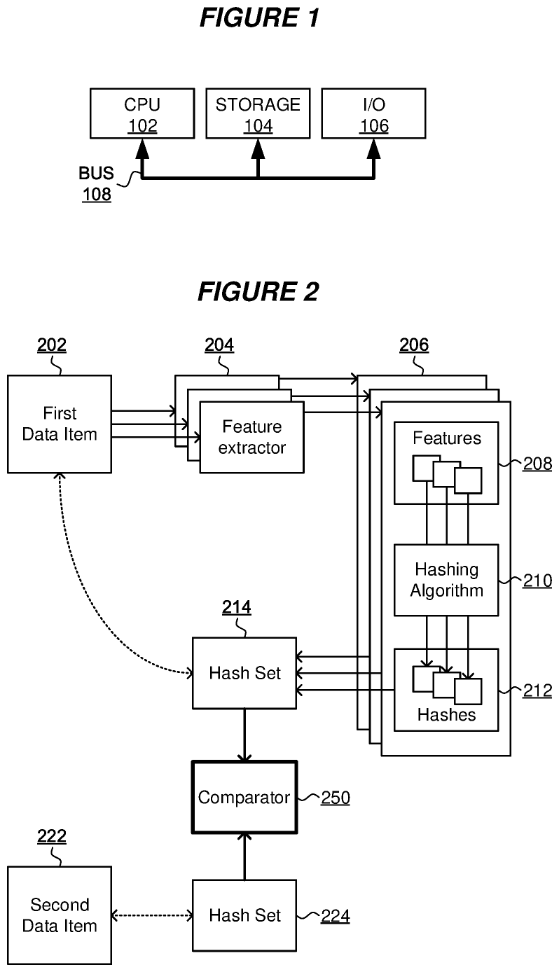

FIG. 1 is a block diagram a computer system suitable for the operation of embodiments of the present invention;

FIG. 2 is component diagram of an exemplary arrangement for determining an association between disparate first and second data items according to an embodiment of the present invention;

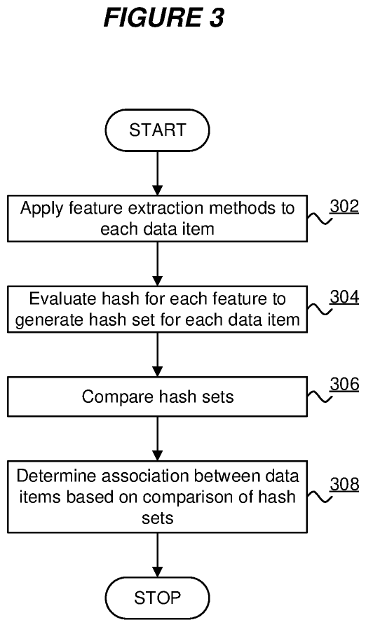

FIG. 3 is a flowchart of a method of determining an association between disparate data items according to embodiments of the present invention.

FIG. 1 is a block diagram of a computer system suitable for the operation of embodiments of the present invention. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

Embodiments of the present invention provide for a determination of an association between different data items where one is at least partly derived from the other. The determination is based on evaluating cryptographic hashes across multiple different feature extraction methods to characterise each data item. Comparisons between data items then take place across the whole suite of feature extraction methods and features determined thereby based on comparisons of the hashes with common hashes indicating derivation. A conventional use of hashes detects even a smallest modification to data. However, such conventional use of hashes to compare data items fails to identify similarities in the data items. By the use of multiple feature extraction methods with hashing of results of each, similarities occurring in only a subset of features are detected to indicate commonality in the data items.

There is no limit on the number and type of features and feature extraction methods that can be employed—ppropriate to the data type of data items. A greater number of features representing different perspectives and/or levels of detail within data items can provide a greater likelihood of identifying similarities between data items. For example, feature extraction techniques can include some or all of, inter alia: image noise extraction; colour distribution determination; intensity distribution; microtexture determination such as edge and corner determination; structure determination such as line, circle, square or other determination; edge identification; object detection such as may be achieved by machine learning techniques; metadata extraction such as Exchangeable Image File Format (EXIF), video, image or document metadata; symbol, meta-symbol, byte, word or phrase frequency measurement; n-gram extraction; syntactic structure identification; and classification such as machine learning classification by autoencoders or the like.

Embodiments of the invention are also suitable where an original data item is specifically modified to include features that are readily susceptible to detection by feature extraction techniques in order to improve an opportunity for detection of derivative data items. For example, noise, watermarks or other features could be inserted, combined or included in a data item to aid feature identification in a derivative.

Some embodiments of the invention generate hierarchies of sets of hashes for a composite data item comprising subsidiary data items included therein. For example, a webpage can include one or more textual or document elements in addition to one or more audiovisual elements such as images, video or sound. Performing feature extraction on constituent elements of a data item (such as by considering each constituent element as a data item in its own right) permits identification of derivatives of individual constituents without derivation of the entire webpage. A hierarchy of such sets of hashes for constituents can be generated as a data structure for subsequent use in detecting derivatives.

FIG. 2 is component diagram of an exemplary arrangement for determining an association between disparate first 202 and second 222 data items according to an embodiment of the present invention. A comparator 250 is provided as a hardware, software, firmware or combination component for comparing hash sets 214 and 224 of cryptographic hashes generated on the basis of each of first 202 and second 222 data items respectively. Commonality of any hash values in the hash sets 214, 224 indicates identity of one or more features in the first 202 and second 222 data items and therefore an association between the first 202 and second 222 data items such that one data item is derived from the other.

The hash set 214 for the first data item 202 is generated based on a plurality of feature extractors 204 each using a disparate feature extraction method such as those described above. Each of the plurality of feature extractors is applied according to a feature extraction method 206 in which features 208 for the first data item 202 are extracted and each feature is processed by a hashing algorithm 210 to generate a hash 212. Thus, each extracted feature 208 for each feature extractor 204 generates a hash 212. For example, a feature can be generated as a representation of the feature such as a visual representation of a visual feature, or a numeric representation of a counting feature, or an symbolic representation of an extracted feature (such as text or the like). Such features are thus constituted as pieces of data in their own right susceptible to processing by application of the hashing algorithm 210 to generate a hash therefor. All hashes generated in this way across all feature extraction methods 206 are compiled into a hash set 214 as a representation of the first data item 202.

The hash set 224 for the second data item is generated in a corresponding manner. Whereas the particular set of feature extractors 204 applied to each data item need not be identical except that there need be overlap (i.e. common feature extraction methods applied) in order for the technique too succeed in identifying common hashes of common features between the data items, the hashing algorithm 210 must be the same for all data items to ensure consistency of hash calculation for common identical features.

The comparator 250 operates in any suitable manner such as by observing any non- empty intersection of the compared hash sets 214, 224 to determine at least some identical hashes. Identity of hashes in the hash sets 214, 224 is indicative of identical features in each of the first 202 and second 222 data items and derivation therebetween.

In one embodiment, the first 202 and second 222 data items are renderable media data items such as video data, image data or sound data, and a similarity therebetween determined by the comparator 250 is indicative of a deepfake.

In some embodiments, the first data item 202 is a known authoritative data item such as an original data item including data as originally generated, and the second data item 202 is determined to be derived from the first using the above described techniques. In such embodiments, access to derivative data items such as the second data item 222 can be precluded, prevented or flagged as a “fake”, derivative, copy or the like or otherwise modified to indicate its non-original nature. For example, the second data item 222 can be deleted or quarantined.

In one embodiment, the first data item 202 is a known authoritative data item such as an original data item including data as originally generated, and the second data item 202 is determined to be derived from the first using the above described techniques. In such an embodiment the hash set 214 for the first data item 202 can be stored in a distributed transactional database such as a blockchain database in order to auditably record the hash set 214 and/or to prove the authenticity of the first data item 202 in a non-repudiable manner (or at least a manner where repudiation is detectable via the blockchain). Subsequently, comparisons between a second 222 (derivative) data item and the original first data item 202 can determine the original data item based on the hash set 214 recorded to the blockchain.

FIG. 3 is a flowchart of a method of determining an association between disparate data items according to embodiments of the present invention. Initially, at step 302, the method applies a plurality of feature extraction methods to each of the first 202 and second 222 data items. At step 302 the method evaluates a hash for each feature extracted by each feature extraction method to generate a hash set 214, 224 for each data item. At step 306 the comparator 250 compares the hash sets 214, 224 to identify identical hashes so that, at step 308, the method determines associations between the data items based on the comparison of the hash sets 214, 224.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present invention has been described in relation to the above described example embodiments, the invention is not limited thereto and that there are many possible variations and modifications which fall within the scope of the invention.

The scope of the present invention includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method of determining an association between disparate first and second data items wherein the second data item is at least partly derived from the first data item, the method comprising:
evaluating a cryptographic hash to each result of each of a plurality of disparate feature extraction methods, each feature extraction method being applied to each of the first and second data items to generate a set of hashes for each data item;
responsive to a non-empty set of hashes in the intersect of the sets of hashes for each data item, identifying an association between the first and second data items and responsive to the identification of an association, identifying the second data item as a derivative of the first data item, and responsive to the identification of the second data item being a derivative of the first data item, preventing access to the second data item.

2. The method of claim 1 wherein the plurality of feature extraction methods include one or more of: image noise extraction; colour distribution determination; intensity distribution; microtexture determination; structure determination; edge identification; object detection; metadata extraction; symbol frequency measurement; n-gram extraction; syntactic structure identification; and classification.

3. (canceled)

4. The method of claim 1 wherein the first and second data items include renderable media data and the association identifies the second data item as a deepfake.

5. (canceled)

6. The method of claim 1 wherein the set of hashes for the first data item are stored in a blockchain database for comparison with the set of hashes for the second data item to identify the intersect of the sets.

7. A computer system including a processor and memory storing computer program code for performing the steps of the method of claim 1.

8. A computer program element comprising computer program code to, when loaded into a computer system and executed thereon, cause the computer to perform the steps of a method as claimed in claim 1.
